(19) United States
(12) Patent Application Publication
(10) Pub. No.: US 2002/0065076 A1
(43) Pub. Date: May 30, 2002

(54) APPARATUS AND METHOD FOR SELECTION OF CIRCUIT IN MULTI-CIRCUIT COMMUNICATIONS DEVICE

(76) Inventor: DAVID A. MONROE, SAN ANTONIO, TX (US)

Correspondence Address: JUDY KRUGER, BRACEWELL & PATTERSON LLP, 711 LOUISIANA STREET, SUITE 2900, HOUSTON, TX, 770022781

(21) Appl. No.: 09/350,197

(22) Filed: Jul. 8, 1999

Related U.S. Application Data
(62) Division of application No. 09/005,931, filed on Jan. 12, 1998.

(51) Int. Cl. H04Q 7/20

(52) U.S. Cl. 455/426

(57) ABSTRACT

A method and apparatus for automatically selecting a transmission protocol for audio and/or data signal captured for transmission at a remote location. The method and apparatus detects the presence of a first priority transmission system and automatically selects the first priority system if it is present, but will select a secondary default system if the first priority system is not available. The method and apparatus of the invention also permits default to a secondary system if the first priority system is available but is inactive for any reason. Multiple priority levels may be implemented. Both wired and wireless transmission systems may be utilized.

This application is a divisional application of U.S. Ser. No. 09/005,931, filed Jan. 12, 1998.

### BACKGROUND OF THE INVENTION

1. Field of the Invention

The invention is generally related to communications devices for transmitting data over wired and wireless transmissions systems and is specifically directed to an apparatus and method for selecting one of a plurality of transmission circuits in a multi-circuit communications device.

2. Discussion of the Prior Art

Wireless technology such as cellular telephones, PCS and the like have made construction and operation of low cost wireless devices commonplace. It is now possible not only to transmit audio signals such as spoken words but also to transmit video images, facsimile images, sensor data, computer data and other analog and digital signals through small, even portable, hand held, devices. For example, a device for transmitting digital video signals via a hand held cellular telephone is shown and described in the co-pending U.S. patent application Ser. No. 09/005,932, entitled: Method and Apparatus for Image Capture, Compression and Transmission of a Visual Image over Telephonic or Radio Transmission System, and filed on even date herewith. That application describes a hand held device for capturing visual images and converting them into a standard Group III format for transmission over cellular telephone or other wireless means to a Group III facsimile system. The device, in one embodiment, contains a cellular telephone with the image capture and transmission device embodied in a integrated hand held unit.

The user of such a device may, at times, prefer to use a transmission system other than cellular/wireless due to lack of adequate cellular service, security concerns, lower cost land line service, faster land line transmission or other reliability issues. In such cases it would be desirable to be able to transmit the captured image via a land line system without relying on any wireless communication system. This often means the system has to be physically disconnected from the wireless communication device and reconnected to the land line communications system.

It would be desirable to provide a means and method for automatically recognizing the presence of a land line connection, thereby intercepting the wireless communication and transmitting the data over the land line without additional input from the user and without requiring physical disconnect and reconnect.

### SUMMARY OF THE INVENTION

The subject invention is directed to a method and apparatus for selecting between wireless or wired operation that is simple and transparent to the user. The switching criteria may be implemented by a solid state switch, a mechanical interface or a voltage, protocol or signal detector to establish priorities and select transmission system depending upon a variety of factors, including quality of signal, costs, encryption requirements and the like.

In the simplest embodiment, a cellular telephone includes an RJ-11 jack which, when not connected to a land line, permits the cellular telephone to operate in the normal manner. Whenever a land line is connected to the RJ-11 jack, the cellular handset operates as a normal land line telephone, with all dialing activating the land line and not the cellular system and with incoming calls being received via the land line. Voice communications operate in a normal wired telephone mode. It is also a feature of the invention that cellular incoming calls may be detected and received via the cellular system during the time when the RJ-11 jack is connected to a land line, whereby incoming cellular calls are not missed. The system is also adapted for incorporating an RJ-45 jack, whereby Internet transmission can be selected on lieu of wireless or other transmission systems. This permits the user to operate over the desirable system, whether the priority is costs, security, reliability, speed or a combination of these criteria. The priority hierarchy is arbitrary, depending on application.

In the preferred embodiments of the invention, means for detecting the presence of a wireline service is provided directly on the cellular handset. This is accomplished by physical insertion of a wireline into the RJ-11 or RJ-45 jack or by electrical detection of the wireline itself. The following embodiments have been incorporated to accomplish this function: (1) a physical switch is installed behind the RJ-11 or RJ-45 jack to detect insertion of a wireline plug; (2) optical detection; (3) detection of a dial tone or other audio detection; (4) detection of line voltage to determine the presence of a connection, (5) detection of the presence of a digital signal or digital protocol to determine the presence of a connection. A combination of detection systems may be utilized for better reliability. For example, if a physical switch is used in combination with the dial tone detector, the system will go into land line mode as soon as a wireline plug is inserted in the RJ-11 jack. However, if no dial tone is detected when a transmission is initiated, the system will default to the wireless mode.

The same methods can also be employed to switch between first priority and second or lower priority transmission systems of the same genre. For example, the system may include a low cost wired, Internet based standard land line primary system and a high cost, wired, secure land line secondary transmission system. The apparatus and method of the present invention permits the system to always select the low cost line, for example, if it is present by being connected through the RJ-45 jack, but will default to the secondary transmission system through the RJ-11 jack if the low cost Internet based line is not connected, or cannot be accessed. Another example would be the use of multiple wireless systems such as PCS wireless backed up by analog wireless or cellular. Wired and wireless systems could also be combined a as primary and secondary systems.

The methods and apparatus of the invention are equally suitable for use with voice communications, data transmission and image transmission (as described in the aforementioned co-pending application). This increases the overall versatility and reliability of the system by eliminating the dependency on one transmission system.

The versatility is particularly valuable for users who must have near uninterrupted service availability. For example, wireless service may not be adequate, or may be altogether unavailable, in certain areas. Interference may effect the quality of the transmission. Security may be an issue. Law enforcement, fire and medical emergency services and other high response or high security users will require reliable transmission systems under a variety of circumstances. The availability of transparent primary, secondary, and even tertiary communications systems are extremely advantageous in such applications.

Therefore, it is an object and feature of the subject invention to provide for a simple and reliable method of and apparatus for selecting one of a plurality of transmission systems for transmitting data.

It is a further object and feature of the invention to provide for a method and apparatus for selecting a transmission system in a transparent manner, without disruption to the user.

It is also an object and feature of the invention to provide for a method and apparatus for automatically selecting between a wired and a wireless transmission system.

It is also an object and feature of the invention to provide for a method and apparatus for selecting between multiple wired systems or between multiple wireless systems.

It is an additional object and feature of the invention to provide for a method and apparatus for automatically selecting between a wired and a wireless transmission system for transmitting visual image data collected by a remote hand held capture and transmission device.

It is yet another object and feature of the invention to provide for a method and apparatus for detecting the availability of a preferred transmission system and for automatically defaulting to a secondary system in the event of unavailability or high error rates.

Other objects and features of the invention will be readily apparent from the drawings and detailed description of the preferred embodiments.

### BRIEF DESCRIPTION OF THE DRAWINGS

FIG. 1 is a perspective view of a switch for an RJ-11 modular style connector incorporating the physical features of the invention.

FIG. 2A is a decision flow diagram consistent with the configuration shown in FIG. 1.

FIG. 2B is a decision flow diagram showing multiple transmission options.

FIG. 2C is a decision flow diagram similar to FIG. 2B, expanded to show a select and failure default loop for each circuit option.

FIG. 2D is a decision flow diagram showing multiple transmission options combining wired and wireless transmission option.

FIG. 3 is a decision flow diagram for a system including a default mode.

FIGS. 4A and 4B comprise perspective views of a hand held device incorporating the features of the invention.

FIG. 5 is a decision flow diagram for a system including primary, secondary and tertiary transmission systems and related default modes.

FIG. 6 is a configuration of the system for a wireless only embodiment using a cellular telephone.

FIG. 7 is a configuration for a three protocol wireless system.

FIG. 8 is a configuration for a three protocol wireless system incorporating a data modem.

FIG. 9 is a configuration for a three protocol wireless system incorporating a data modem in combination with an audio transmitting and receiving capability.

FIG. 10 is a configuration for a three protocol wireless system for use with an agile wireless radio transmission system.

FIG. 11 is a configuration for a three protocol wireless system for use with an agile wireless radio transmission system and incorporating a data modem.

FIG. 12 is a configuration for a three protocol wireless system for use with an agile wireless radio transmission system and incorporating a data modem in combination with an audio transmitting and receiving capability.

FIG. 13 is similar to FIG. 9 showing a multiple input system combination for both wireless and wired systems in combination with discrete circuitry.

FIG. 14 is a system having multiple input capability with multiple wired and wireless systems in combination with shared circuitry.

FIG. 15 is a DSP based highly integrated configuration of the invention.

### DESCRIPTION OF THE PREFERRED EMBODIMENTS

The preferred embodiments of the invention comprise a method of and apparatus for transparently selecting one of a plurality of transmission schemes for transmitting audio and/or data signals from a hand held, portable signal capture device. The connections to the transmission system can be any compatible method including, by way of example, an RJ-11 switch for land line telephone, an 8 pin modular jack such as an RJ-45 type jack, for ISDN, LAN, Internet or Ethernet transmission, or other. While for convenience of discussion reference is made to RJ-11 and RJ-45 jacks throughout the description, such terms are not intended to be limiting.

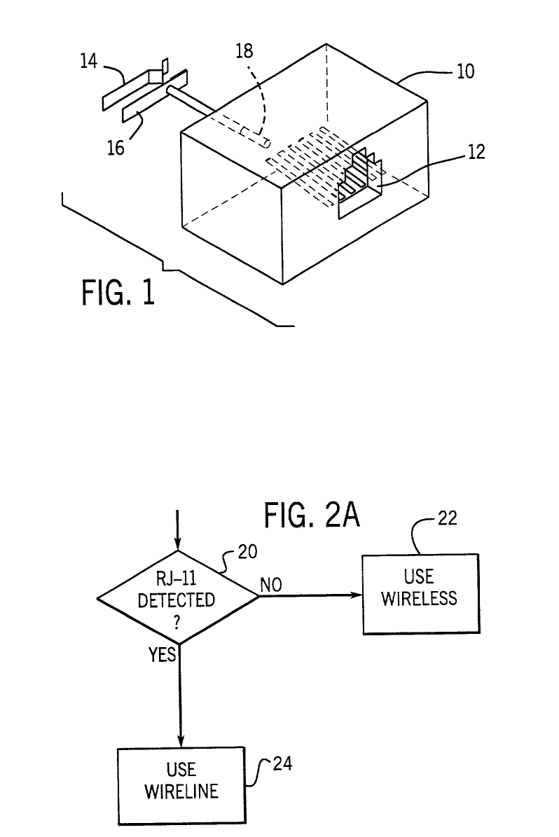

A physical switch configuration is shown in FIG. 1 and utilizes an RJ-11 modular jack which can be installed in hand held, portable data capture and transmission device. In the simplest form, a cellular telephone or similar portable device would include the RJ-11 modular jack 10 installed directly in the unit.

As shown in FIG. 1, the modular jack 10 includes a receptacle or socket 12 adapted for receiving a standard mated plug (not shown) on a wireline POTS (plain old telephone service) telephone system. A pair of switch contacts 14, 16 are provided with a plunger 18 being positioned to be intercepted by the wireline plug when it is inserted in the receptacle 12. When the wireline plug is inserted, the plunger 18 is engaged and moved to close the contacts 14 and 16, completing the circuit therebetween, positively indicating the presence of a wireline plug. The system then sends the transmissions over the wireline rather than over the cellular system.

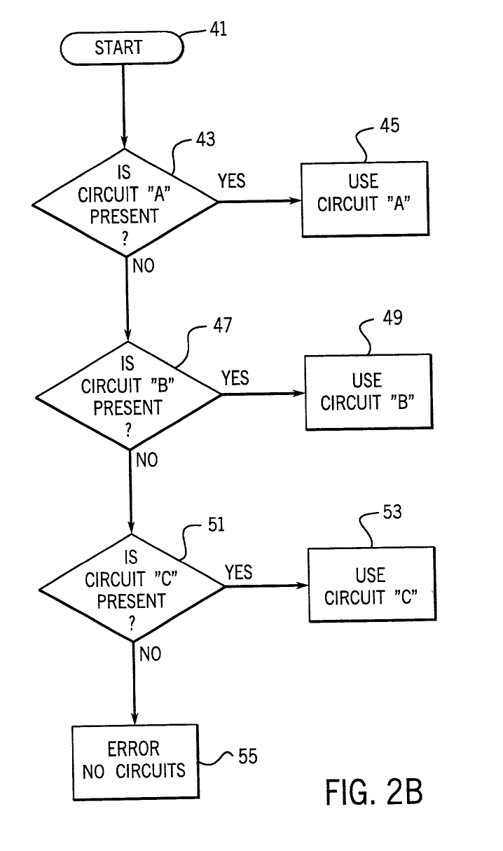

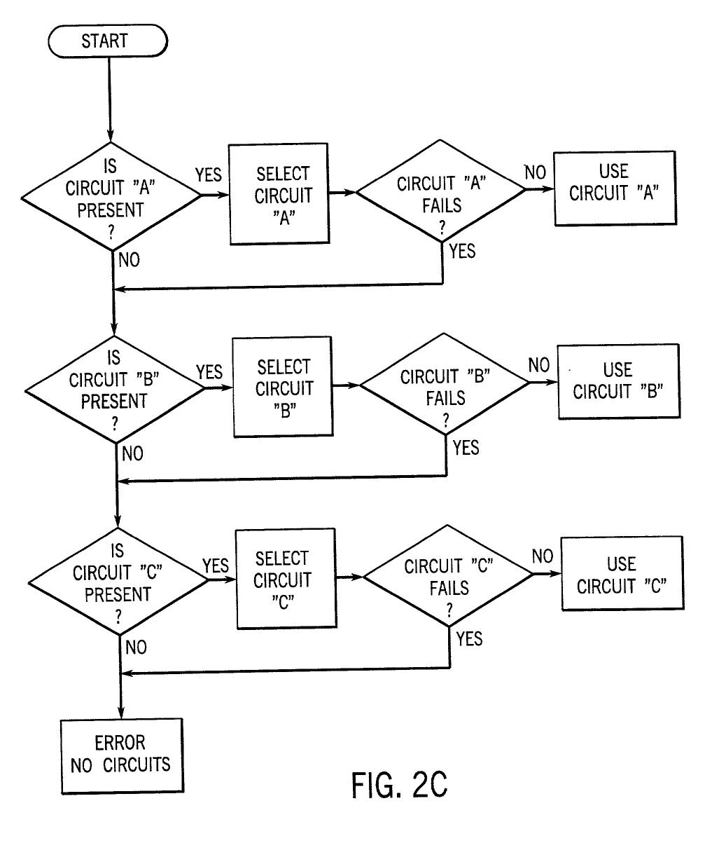

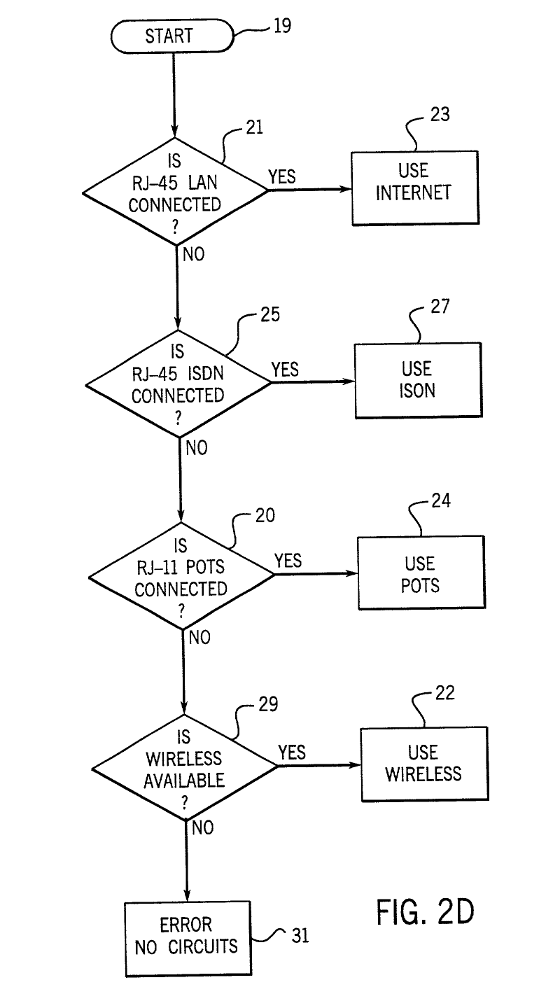

A simple decision flow diagram for this system is shown in FIG. 2A. As there shown, the contacts 14, 16 define the basic decision block 20 for determining the presence of the wireline connection. If the wireline is detected, then all transmissions are via wireline as indicated at 24. If the wireline is not present, then all transmissions continue to be via the wireless system as indicated at 22.

FIG. 2B shows a generic flow diagram for selecting a prioritzed transmission system based on either pre-programmed priority parameters, or on operator input, as will be further explained. Once the presence of a signal to be transmitted is detected as indicated at Start 41, the highest priority system is initially checked as indicated at 43 and transmission is initiated by the YES decision and as indicatd at circuit “A” 45. In the event the highest priority system is not available a NO decision then initiates the detection of the presence of the next priority system “B” 49 as indicated at decision block 47. This continues in hierarchal order through system “C” 63 as decision block 51, and so on. If no system is availabe, an ERROR signal is generated at 55. The classes or systems and number of systems utilized is virtually limitless.

FIG. 2C is also set up to select and use, in priority order, circuit “A” 45, circuit “B” 49 or circuit “C” 53, as in FIG. 2C. In addition, the system of FIG. 2C includes a select and default loop for each circuit, as indicated by the select circuit “A” block 57 and the failure check mode identified as the circuit “A” fails decision block 59. As shown, if circuit “A” is determined to be present at 43, it is selected as indicated at 57. Then secondary check at 59 permits the system to default back to the priority selection process in the event circuit “A” fails for any reason. Similar select and default blocks are provided for each of the circuit options, as indicated by blocks 61 and 63 for circuit “B” 49, and blocks 65 and 67 for circuit “C” 53.

FIG. 2D shows a decision flow diagram for a multiple level system incorporating the teachings of FIGS. 1 and 2A. The apparatus and method of the invention permit transparent selection of any first priority transmission system over secondary systems, as demonstrated in FIG. 2B. This is true whether the wired systems is landline telephone, Internet, network or other. The system also permits prioritizing connections to maximize transmission criteria. For example, if security is the primary criterium, then the priority system would be of highest security. If cost is the major issue, then the first priority would be the lowest cost transmission alternative. FIG. 2A shows a system with four transmission options in a prioritized hierarchy. When a transmission is initiated, as shown at 19, the system first checks for the lowest cost connection, such as the Internet on an RJ-45 network connection at 21 and uses the Internet as indicated at 23, if available. If the Internet connection is not available at 25, the system defaults to an ISDN connection, as shown at 27. The third priority is landline telephone (POTS) as indicated at 20, which is chosen, if available, see 24. In the event none of the above are available, the system defaults to wireless, see 29 and 22, or indicate error, as at 31, if no system is operable. The priority scheme and the options available is arbitrary, based on application.

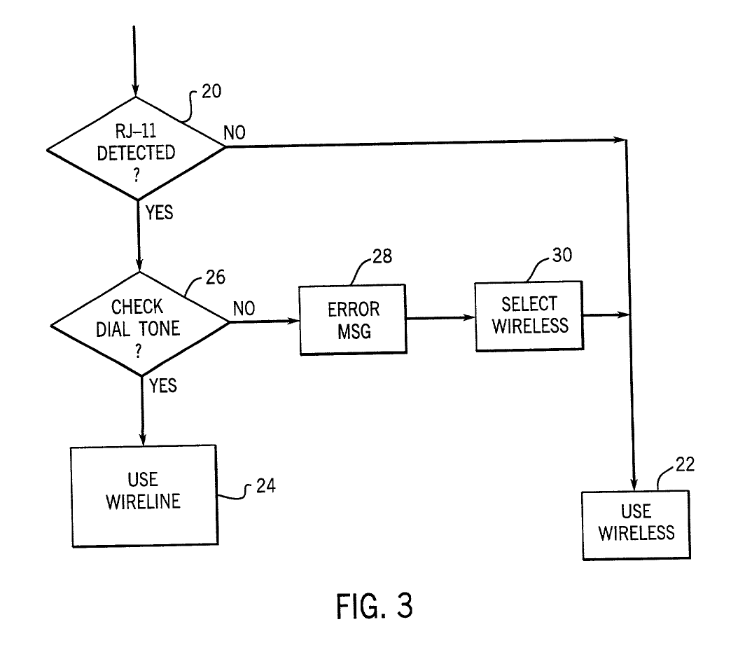

It is desirable that the system be capable of confirming that the wireline is not only available but is also in an operative mode to assure proper transmission. As shown in FIG. 3 once the presence of a wireline has been detected at 20, the operability of the wireline is confirmed by checking for the presence of a dial tone, as shown at 26. If a dial tone is detected, the wireline is selected as indicated at 24. If a dial tone is not detected, the system defaults to wireless, as indicated at 30. Where desired, an error message can be sent to the user, as indicated at 28, to alert the user that the wireline transmission system is not being use even though it was selected. This may be particularly important for security issues, and will permit the user to interrupt transmission if the default mode is not acceptable.

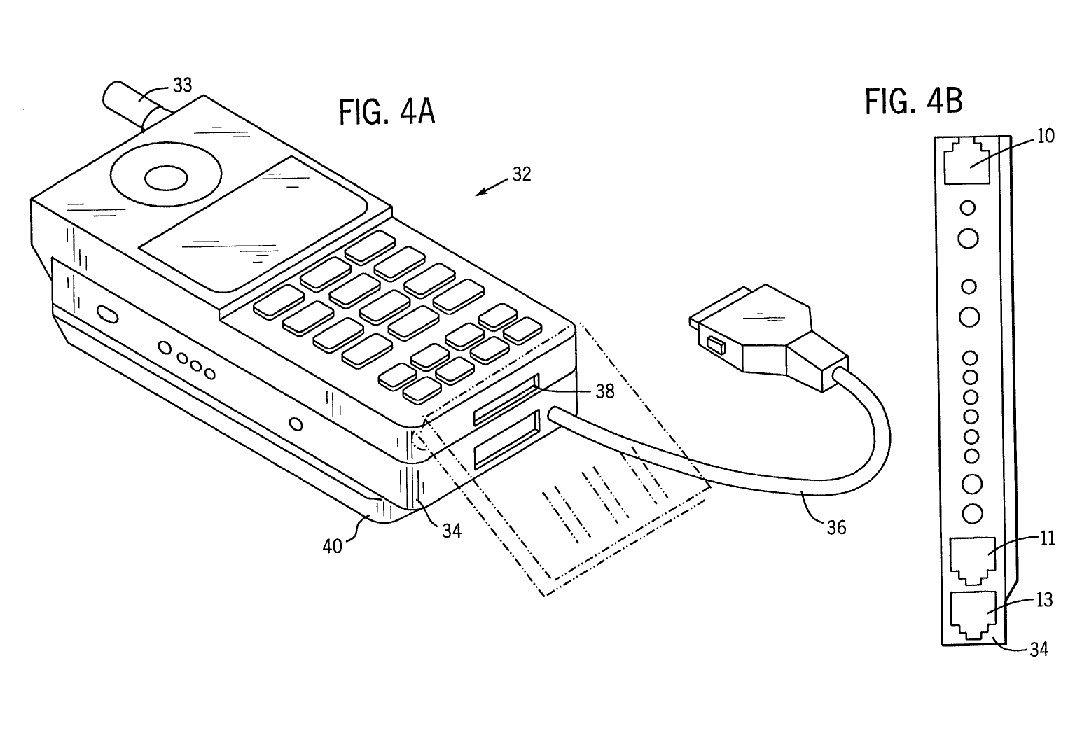

A typical cellular telephone device 32 with a visual image transmission module 34 attached to it is shown in FIGS. 4A and 4B. The visual image transmission module 34 is connected to the cellular telephone via the cable 36 and the data port 38 on the telephone. The standard battery pack 40 is mounted on the visual image transmission module 34. This system is more fully described in the aforementioned co-pending application Ser. No. 09/005,932, entitled: Method and Apparatus for Image Capture, Compression and Transmission of a Visual Image over Telephonic or Radio Transmission System, filed on even date herewith and incorporated by reference therein. The RJ-11 jack 10 is mounted in the module 34 and the logic circuitry for operating the switching and verification sequence is located in the module, thus eliminating any modification of the base telephone unit 32. An ISDN RJ-45 jack II and an LAN RJ-45 jack 13 is also provided. The wireless transmission is transmitted via the antenna 33.

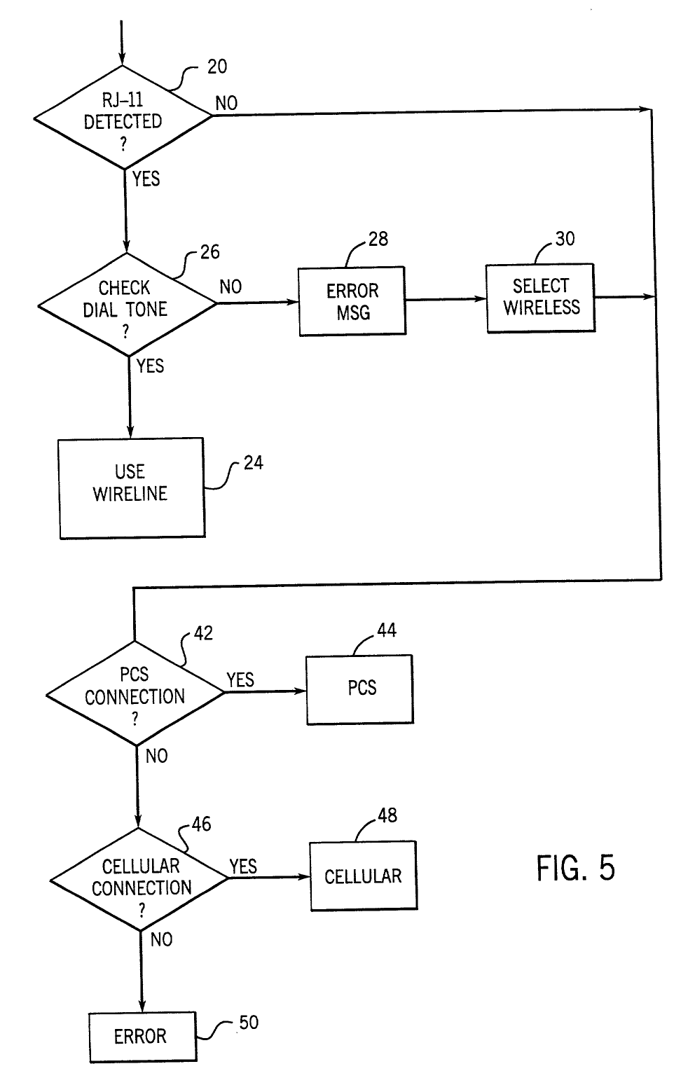

FIG. 5 is a basic decision flow diagram for a three protocol system. As wireless services become more pervasive, additional types of services will become available. There are currently available analog AMPS format, E-AMPS, N-AMPS, PCS, GSM and digital versions of AMPS systems. “Satellite Cellular” systems such as proposed in Iridium, Teledesic and others are also scheduled to come into service. These services, in any order and mix, can be prioritized and automatically selected. As shown in FIG. 5, a facsimile camera or other data capture system (not shown, see FIG. 4) can implement a wireline interface, a PCS interface and/or a cellular interface in any selected prioritization, for transmission, for example, to any Group III facsimile receiving station. The services can be configured to select the highest priority based on user criteria such as cost, security, reliability and/or speed of transmission. For example, one system may have priority over another for data transmission because of reliability issues, whereas a second system may have priority for voice transmission because of cost issues. The method of priority can further be user selected, such as costs, security, personal/business use and the like.

As shown in FIG. 5, the basic decision detecting the presence of a wireline is made at 20, utilizing the RJ-11 switch as in the previous configurations. If a wireline is present, the logic proceeds as shown in FIG. 3, and as indicated at blocks 20, 26, and 24. In the event a wireline is not present, the system will first look for a PCS connection, as indicated at 42. If detected the PCS system is activated as indicated at 44. If the PCS system is not detected, the system attempts to select a cellular system as indicated at block 46. If the cellular system is detected, it is activated as indicated at 48. If none of the systems are detected or active, an error signal is produced as shown at 50. That is, if the PCS connection is not successful, the system defaults back to a cellular service.

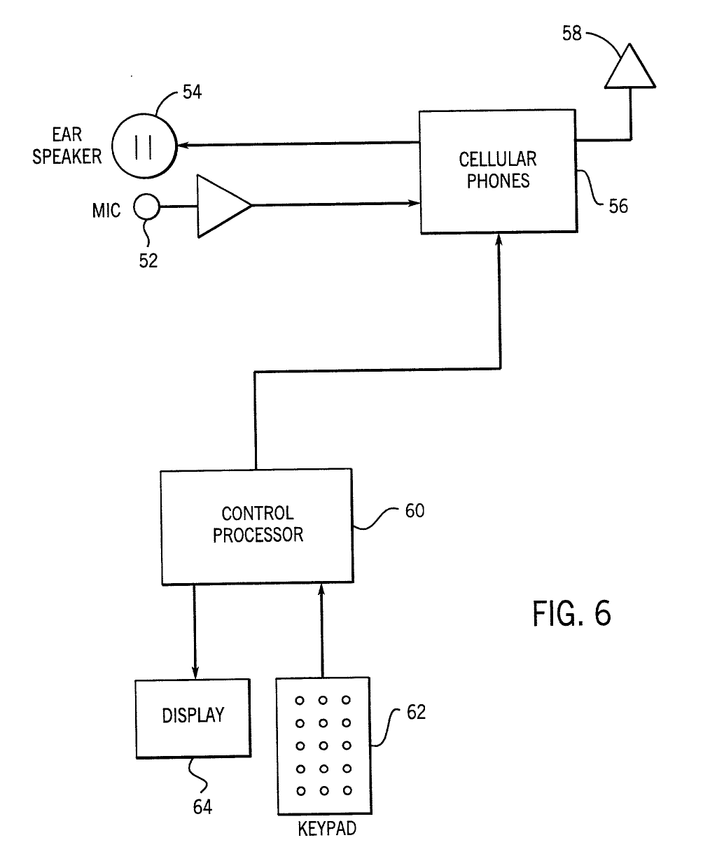

FIG. 6 is an illustration of a system wherein one of a plurality of cellular telephone systems, as indicated at 56, would be selected based on predetermined criteria in the control processor 60, for transmission via the antenna 58. The voice input and output of the system is throught the microphone 52 and the speaker 54, respectively. The control processor 60 may be preprogrammed or may be operator controlled, as indicated by the keypad 62, with operator monitoring at display 64. The system permits selection of a transmission scheme based on three distinct criteria groups: (1) type of input/output; (2) operating parameters or conditions; and (3) type of transmission. For example, the input may be either digital or analog under group (1). The operating parameters may include costs, quality of transmission, requirement for encryption, type of transmission, e.g., personal or business, geographic limitations, and the like. Transmisson systems can be any of the availble systems ranging from, by way of example, land line telephone, cellular telephone, radio, Internet, Ethernet, LAN and other systems.

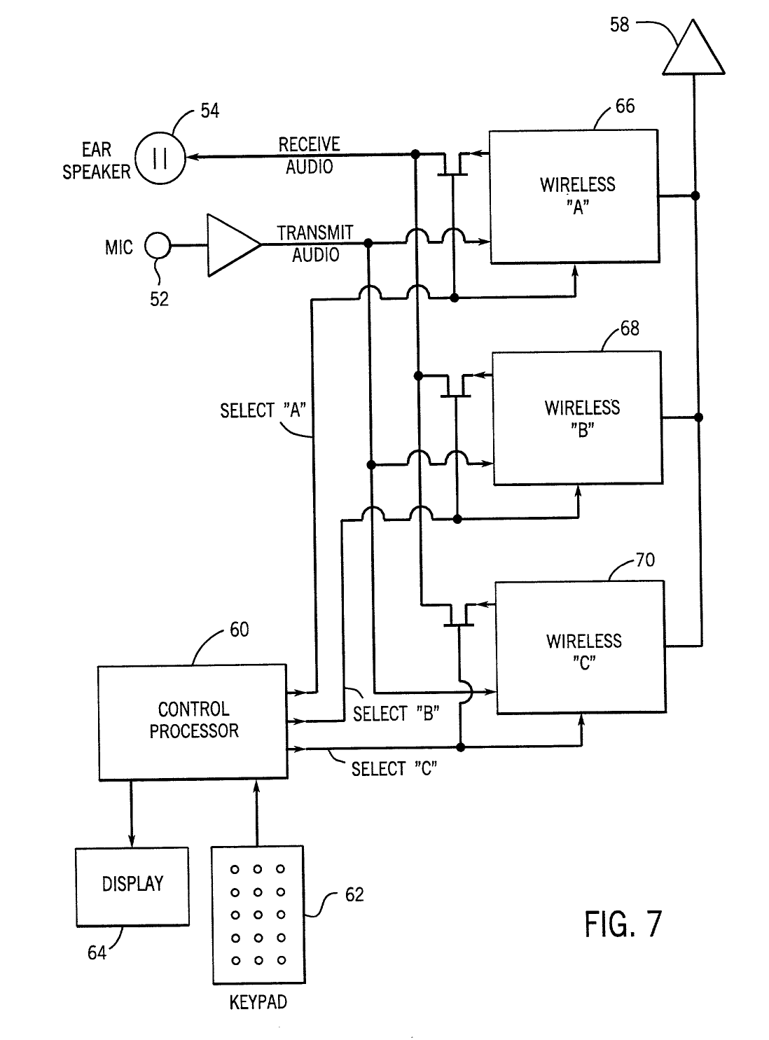

The logic circuitry and decision logic for a first configuration utilizing a plurality of wireless transmission schemes is shown in more detail in FIG. 7. Multiple wireless transceivers of the same or different genre are supported by this configuration. For example, Wireless “A” 66 could be a cellular telepephone, whereas wireless “B” could be a dedicated frequency radio and wireless “c” an agile frequency radio. Any combination can be utilized based on application. In the configuration shown, the control processor will use a logic decision flow in the same manner as set forth in FIG. 5 to select between wireless A transmission system 66, wireless B transmission system 68 and wireless C transmission system 70. For example, the wireless A system 66 may be first priority, corresponding to a “yes” decision at block 20 of FIG. 5. Wireless A cannot be detected, the system defaults first to wireless B and then to wireless C. If no system can be accessed, an error signal will be provided at display 64.

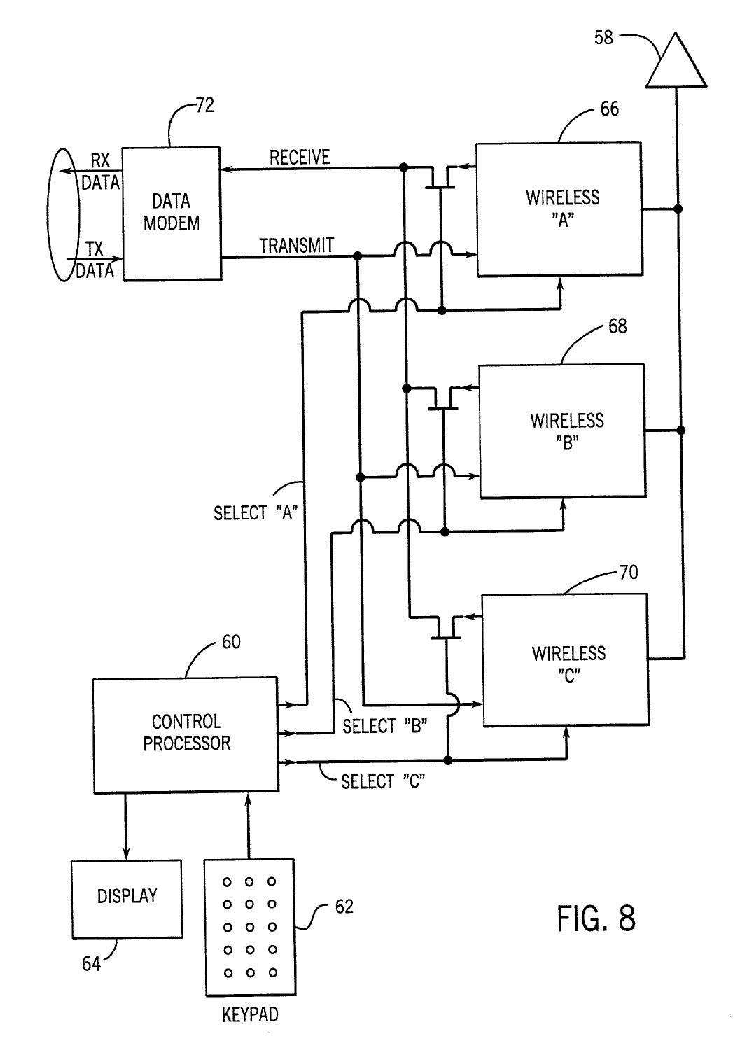

FIG. 8 illustrates a system similar to the configuration shown in FIG. 7, but adapted for data transmission. In the system there shown, a data modem 72 provides the input/output device for the radio transmission systems 66, 68 and 70.

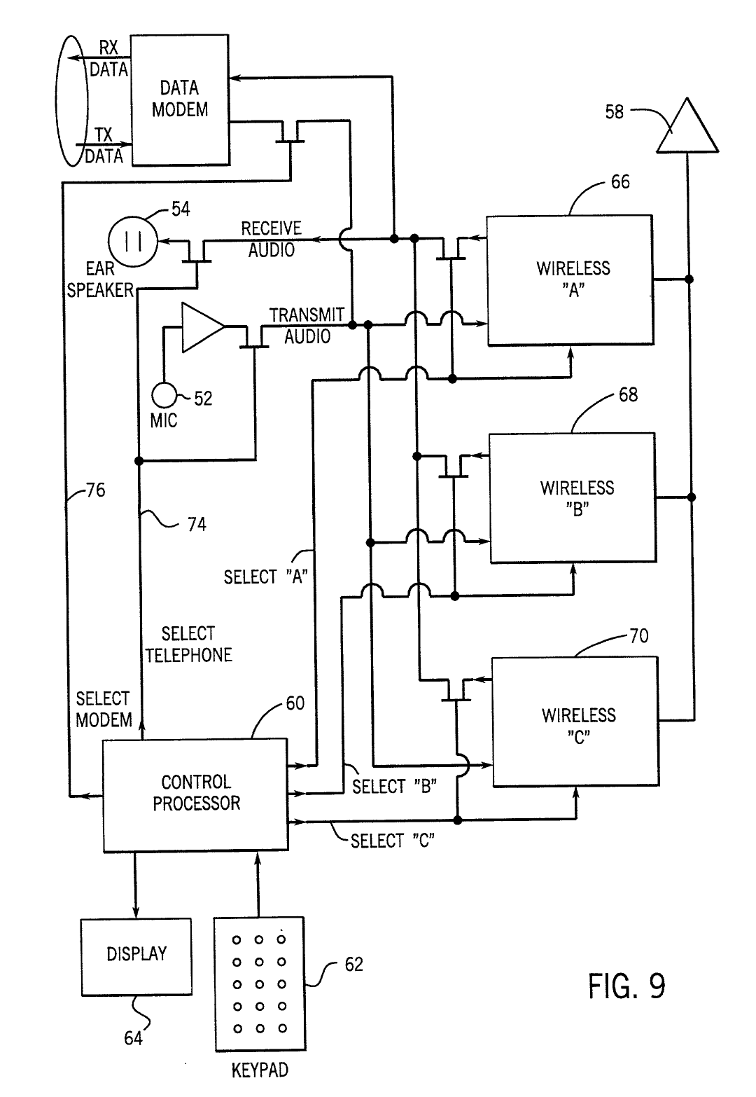

FIG. 9 illustrates a combination data and audio system, and as indicated includes logic for selecting either the audio mode or the data mode, see control lines 74 and 76, respectively. The mode may be selected either by input from the keypad 62 or may be automated to detect either a data signal or an audio signal.

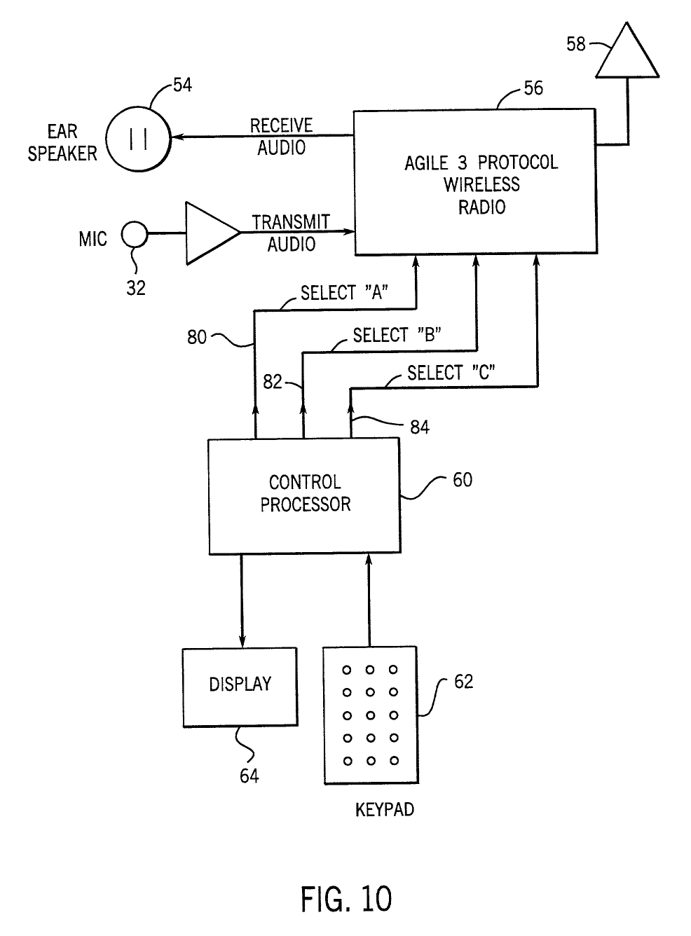

Multiple communication schemes, such as multiple individual radios, or a single universal programmable radio, may be used for multiple wireless service systems. A single programmable agile radio is a preferred embodiment because less hardware, space and power is required by the universal radio. This configuration is illustrated in FIG. 10 for an audio transmission device. Multiple system schemes are particularly useful for users having near 100% circuit availability requirements, such as, by way of example, law enforcement or emergency operations. Any single wireless service may not be available at a given moment because of geographic proximity of the radio system, equipment failure, circuity unavailability due to heavy usage, electrical interference, or other service interruptions. Many user systems currently rely on a dedicated transmission system such as, by way of example, a dedicated municipal radio system. While these are often proprietary and are not based on common carriers and standard circuits such as PCS or cellular systems, they can be overloaded or inoperative at times, making emergency transmissions difficult. By creating a secondary proprietary or even a common carrier backup, critical time can be saved when primary transmission systems are non-functional.

As shown in FIG. 10, a typical wireless radio transmission circuit in accordance with the present invention will include an audio input device such as microphone 32 and an audio output device such as speaker 54, providing input to a programmable wireless radio 56, in the well known manner, for transmission via a typical antenna 58. The teachings of the subject invention may be incorporated by utilizing the control processor 60 to define and program the logic decisions via an input device such as keyboard 62. An optional display system may be provided. The select controls 80, 82 and 83 for the programmable radio 56 identify the radio system or frequency for transmission based on predetermined criteria.

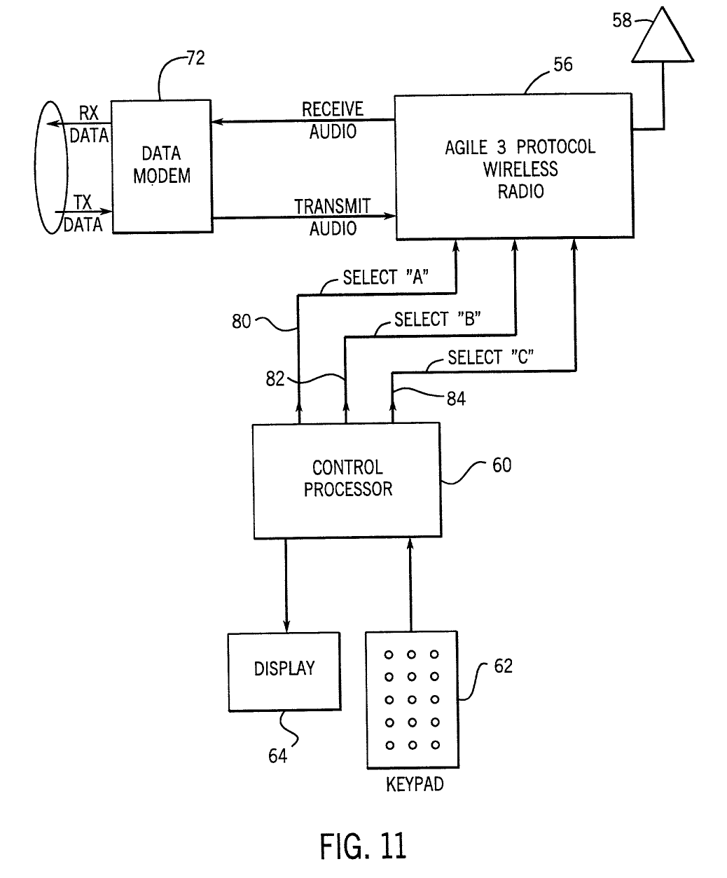

FIG. 11 is similar to FIG. 10 adapted for data transmission.

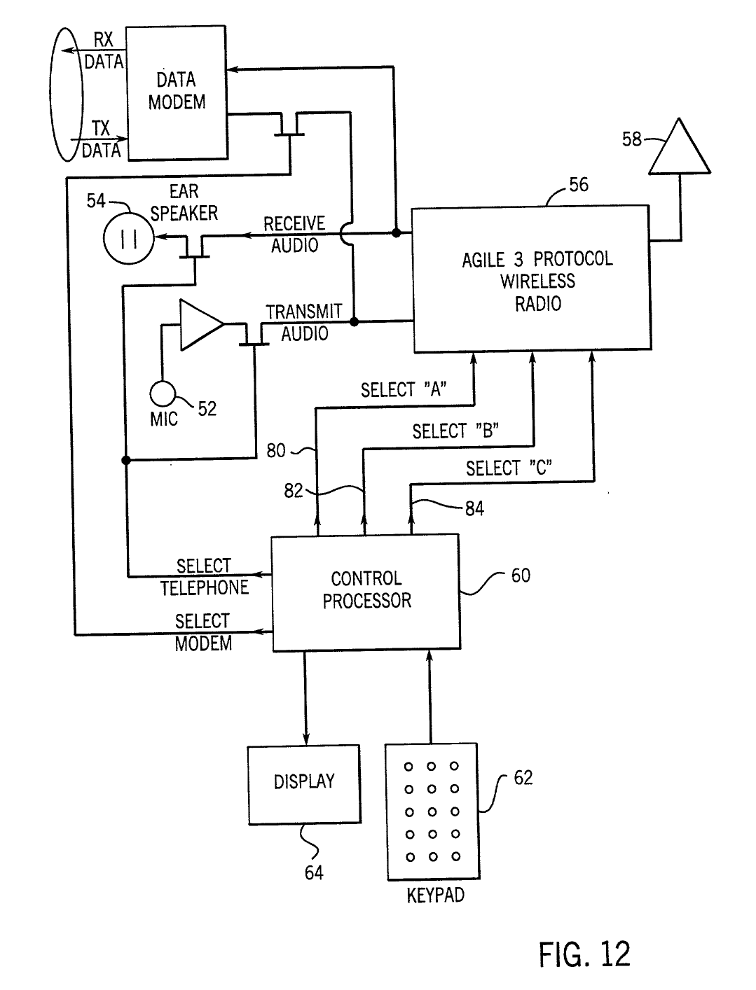

FIG. 12 is a configuration similar to FIG. 10 adapted for a combination audio and data system, along the lines of the system shown in FIG. 9.

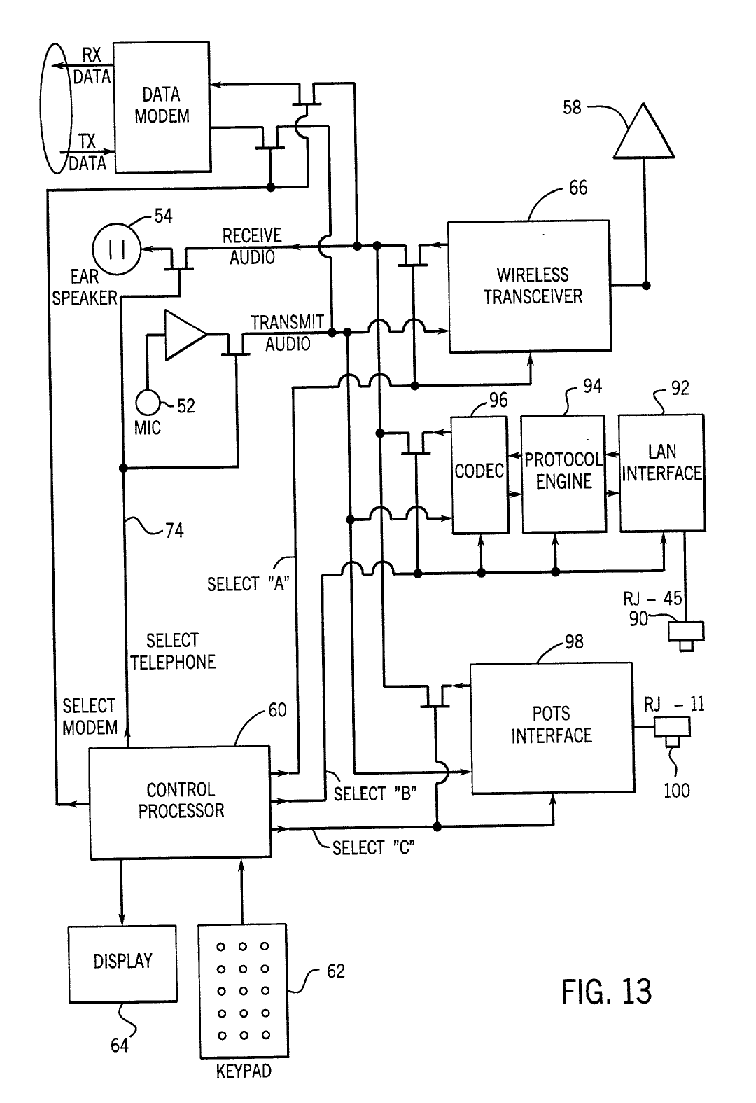

FIG. 13 is similar to FIG. 9 and shows a system capable of selecting between the wireless transceiver 66, a wired LAN connected through the RJ-45 jack, the LAN interface 92, protocol engine 94 and the CODEC module 96, or the POTS interface 98 and RJ-11 jack 100 utilizing discrete circuitry depending on the transmission system selected. In this embodiment, there are three genre or classes of transmission available, wireless as indicated by transceiver 66 and antenna 58; wired LAN as indicated the the CODEC module 96, the protocol engine 94 and the LAN interface 92, with an RJ-11 connector jack 90; and land line or POTS telephone, as indicated by the POTS interface 98 and the RJ-11 connector jack 100. The input may be either digital, as indicated by the data modem 53, or analog, as indicated by the microphone 52 and the speaker 54. Where an analog transmissions system is used, sych as the wireless transceiver or the POTS interface, the analog input is connected directly to the transceiver. Where a digital input signal is to be sent over an analog output system the signal is converted, and likewise, where an analog signal is sent over digital transmission systems. For example, the CODEC module compresses and digitizes analog audio input for transmission via the internet and decompresses and converts digital signal recieved via the internet for receipt at the analog I/O device such as speaker 54.

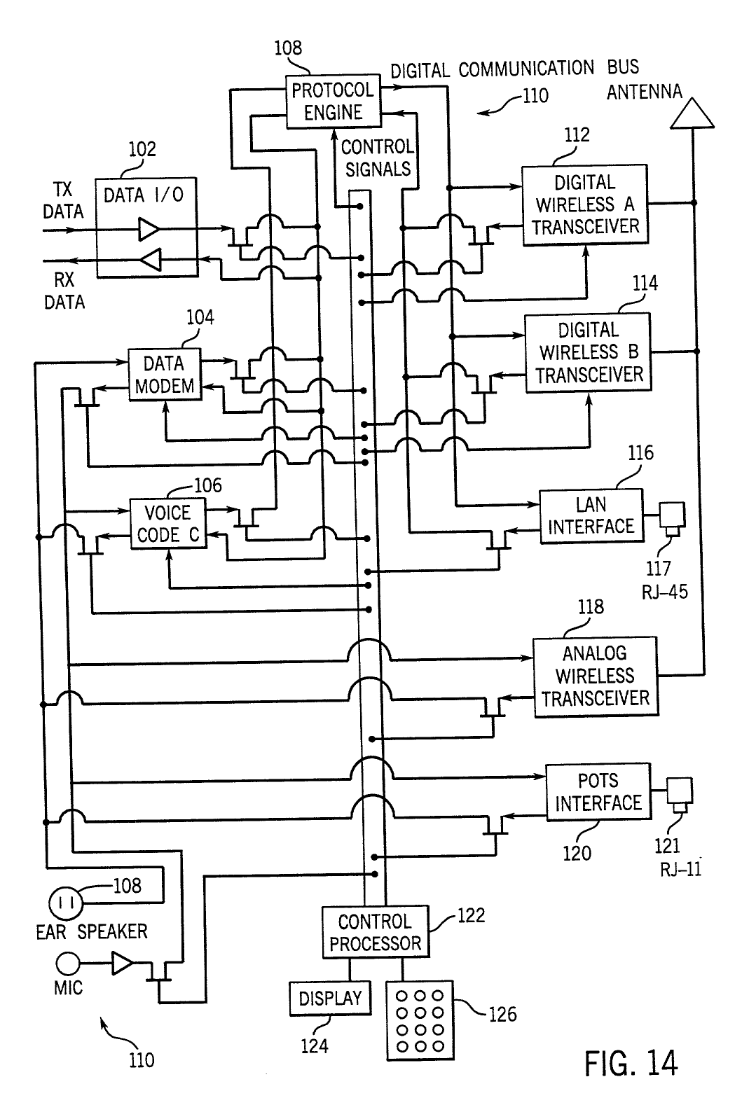

FIG. 14 is a comprehensive system for transmitting text data via an I/O device, or a modem interface 104, as well as voice via the voice CODEC module, as in FIG. 13, but utilizes a shared circuitry or complex circurity configuration. In this configuration, three input devices are provided, a digital text data I/O 102, a digital data modem 104 and an analog I/O comprising Micropone 110 and speaker 108. The analog data bus is provided as indicated at 111, 113, and when conversion between digital and anolg voice signals are required, the voice CODEC 106 is employed. A digital data bus is provided at 107, 109 for directing the digital signal to a protocol engine for provided output sinals in proper protocol on signal bus 113, 115. The example shown in FIG. 10 supports transmission over a plurality of analog and digital transmission systems, as follows: a first digital wireless system “A” 112, a second digital wireless system “B ” 114, a digital LAN system 116 supported by the RJ-45 jack 117, an analog wireless tranceiver 118 such as a cellular telephone and a land line telephone sytem as indicated by POTS interface 120 supported by RJ-11 jack 121. As previously described, the analog signals bypass the protocol engine 111 when transmitted or received via an analog system. The control processor 122 provides control parameters including the priority selection procedure and may be operator controll at keypad 126 or may be pre programmed. A display 124 provides operator monitoring capability. This system will permit complex priority decisions. For example, one transmission system may be first priority for a voice only transmission, whereas a second system may be first priority for a text only data transmission. Time of day may be a factor in choosing priorities as well, depending on whether a transmission is sent during peak or off-peak periods.

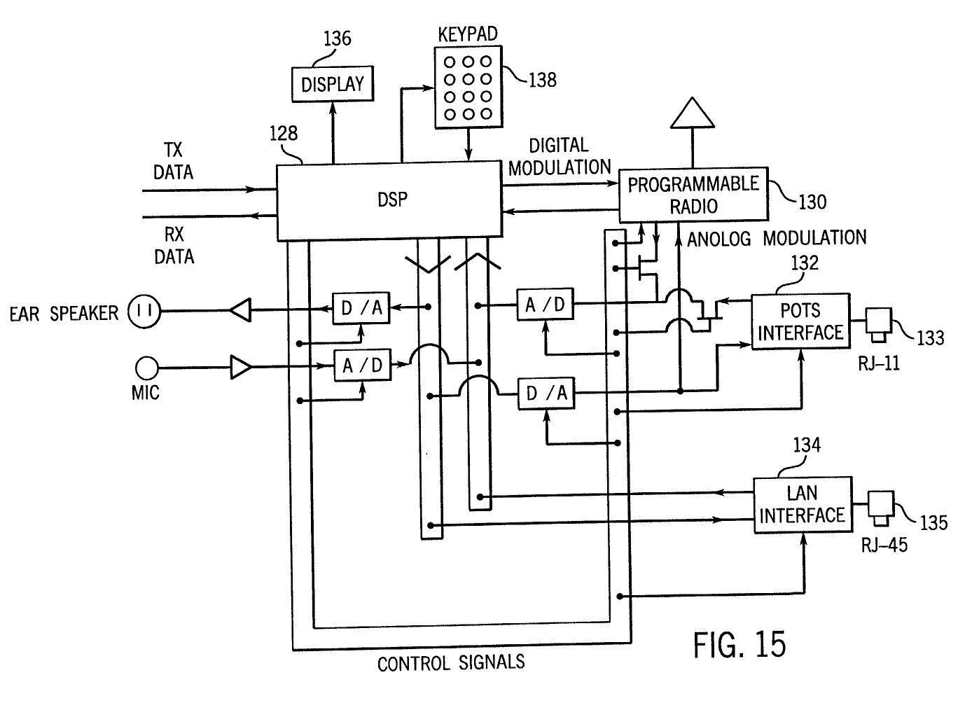

FIG. 15 is a DSP based highly integrated embodiment of the complex, combination system as shown in FIG. 14, with all of the input from the data device and voice systems being input into a central processor 128 for conditioning. The output from the processor is then introduced to the various transmission interfaces, including the agile radio 130, POTS interface 132 and RJ-11 jack 133, and the LAN interface 134 and RJ-11 jack 135. As before, operator monitoring and control is provided by the display 136 and the keyboard interface 138. The processor 128 provices the functions of the protocol engine, the CODEC, various I/O conditioning schemes, as well as control parameters for selecting and prioritizing transmission systems. The DSP processor also provided check switch status, and can monitor and check for the presence of line voltages or various audio signals such as a dial tone, busy tone, progress tone, modem tones, ringing tones and the like to determine the availability and operability of the selected transmission schemes. The processor is also utilized to check for and confirm the presence of data and to verify the protocol for transmission and receipt. Where desired, the processor can be utilized for general purpose functions, as well, such as network supervision, and system monitoring and control.

The method and apparatus of the subject invention greatly enhances the reliability of data and audio transmission by providing multiple transmission schemes which may be automatically selected without input from the user. While certain features and embodiments of the invention have been described in detail herein, it will be readily understood that the invention includes all modifications and enhancements within the scope and spirit of the following claims.

What is claimed is:

1. A method of selecting a transmission system from a plurality of transmission systems for input signals captured at a remote location, comprising the steps of:
a. providing access to multiple transmission systems in a prioritized hierarchy;
b. detecting the presence of the highest priority transmission system;
c. selecting the highest priority transmission system;
d. selecting the next highest priority transmission system if the highest priority transmission system is not available.

2. A method in accordance with claim 1, wherein the detecting step includes the steps of:
a. verifying the presence of the highest priority transmission system;
b. confirming the operability of the highest priority transmission system.

3. A method in accordance with claim 1, wherein the input signal is a data signal.

4. A method in accordance with claim 1, wherein the input signal is an audio signal.

5. A method in accordance with claim 1, including a plurality of input signal formats comprising a data signal and an audio signal, the method further including the steps of:
a. determining whether the signal is of one class or another class signal;
b. selecting a first transmission system as the highest priority transmission system if the signal is aof said one class;
c. selecting a second transmission system as the highest priority transmission system if the signal is of said other class.

6. A method in accordance with claim 2, wherein one of said transmission systems is wired.

7. A method in accordance with claim 6, wherein said wired transmission system is a land line POTS telephone.

8. A method in accordance with claim 6, wherein said wired transmission is an Internet connection.

9. A method in accordance with claim 6, wherein one of said transmission systems is wireless.

10. A method in accordance with claim 9, wherein said wireless transmission system is a cellular telephone system.

11. A method in accordance with claim 9, wherein said wireless transmission system is a PCS (Personal Communication Services) radio system.

12. A method in accordance with claim 2, wherein each of said transmission systems is wireless.

13. A method in accordance with claim 2, wherein at least one of said wireless transmission systems is a cellular telephone system and at least one other of said wireless transmission systems is a PCS (Personal Communication Services) radio system.

14. A method in accordance with claim 2, wherein all of said transmission systems are PCS (Personal Communication Services) radio systems.

15. An apparatus for selecting one of a plurality of transmission systems for transmitting an input signal captured by a remote device, comprising:
a. a connector for connecting the device to a first transmission system interface;
b. a second, default transmission system provided as an integral component of the device;
c. a detector for detecting the presence of a first transmission system;
d. a control system for selecting the first transmission system whenever it is present and for selecting the default transmission system whenever the first transmission system is not present.

16. An apparatus in accordance with claim 15, further comprising a verification device for confirming the operability of the first transmission system, once detected, wherein said control system is operable to select the default transmission system whenever the first transmission system is inoperable.

17. An apparatus in accordance with claim 15, wherein said detector is adapted for detecting the physical presence of the first transmission system interface.

18. An apparatus in accordance with claim 15, wherein said detector is a switch having an activated position and a deactivated position, and wherein the presence of a first transmission interface engages the switch and moves it from the deactivated position to the activated position.

19. An apparatus in accordance with claim 18, wherein said detector is a signal detector operable to initiate transmission in the presence of a predetermined signal.

20. An apparatus in accordance with claim 19, wherein said signal is a voltage level.

21. An apparatus in accordance with claim 19, wherein said signal is an audio signal.

22. An apparatus in accordance with claim 15, wherein the input signal is a data signal.

23. A apparatus in accordance with claim 15, wherein the input signal is an audio signal.

24. An apparatus in accordance with claim 23, including a plurality of input signal formats comprising a data signal and an audio signal, the apparatus further comprising a signal detector for determining whether the signal is a data signal or an audio signal. wherein the control system is adapted for selecting the first transmission system if the signal is a data signal and selecting the second transmission system if the signal is an audio signal.

25. An apparatus in accordance with claim 15, wherein one of said transmission systems is wired.

26. An apparatus in accordance with claim 15, wherein one of said transmission systems is wireless.

27. A method of selecting a transmission system from a plurality of systems by establishing prioritizing critera based on input signals, operating conditions, wherein one of the operating conditions is the determination of whether the transmission is ocurring during peak or off-peak periods, and functionality of the selected transmission system, comprising the steps of:
a. establishing a priority hierarchy based on three sets of criteria comprising: class of input signal, operating conditions and functional characteristics of the transmission systems;
a. providing a first priority transmission system;
b. providing at least a second priority transmission system;
c. selecting the first priority transmission system over the second priority transmission system for transmitting the input signal captured at the remote location;
d. defaulting to the second priority transmission system in the event that the first priority transmission system is not available.

28. An apparatus for selecting one of a plurality of transmission systems for transmitting an input signal captured by a remote device, comprising:
a. a portable handset transceiver;
b. a connector for connecting the handset to a first transmission system interface;
b. a second, default transmission system provided as an integral component of the device;
c. a detector for detecting the presence of a first transmission system;
d. a control system for selecting the first transmission system whenever it is present and for selecting the default transmission system whenever the first transmission system is not present.

29. An apparatus as called for in claim 28, wherein said handset is a wireless transceiver and wherein said connector is an RJ-11 jack for connecting the handset to a wire line telephone system.

30. An apparatus as called for in claim 28, wherein said handset is a wireless transceiver and wherein said connector is capable of supporting an Internet, Ethernet or LAN connection.

31. An apparatus as called for in claim 30, wherein said connector is a modular eight-pin jack.

32. An apparatus as called for in claim 30, wherein said connector is an RJ-45 jack.

33. A processor based apparatus for selecting a transmission system from a plurality of systems by establishing prioritizing critera based on input signals, operating conditions and functionality of the selected transmission system, comprising:
a. means for establishing a priority hierarchy based on three sets of criteria comprising: class of input signal, operating conditions and functional characteristics of the transmission systems;
b. means for providing a first priority transmission system;
c. means for providing at least a second priority transmission system;
d. means for selecting the first priority transmission system over the second priority transmission system for transmitting the input signal captured at the remote location;
e. means for defaulting to the second priority transmission system in the event that the first priority transmission system is not available.

34. A processor based system as called for in claim 33, wherein said priority criteria is pre-programmed.

35. A processor based system as called for in claim 34, wherein said priority criteria is operator controlled.

36. A processor based system as called for in claim 34, wherein said processor is further programmed to provide means for verifying the presence of a transmission circuit.

37. A processor based system as called for in claim 34, wherein said processor is further programmed to provide means for determining switch status.

38. A processor based system as called for in claim 34, wherein said processor is further programmed to provide means for determining the presence of line voltage.

39. A processor based system as called for in claim 34, wherein said processor is further programmed to provide means for detecting the presence of an audio signal or tone.

40. A processor based system as called for in claim 34, wherein said processor is further programmed to provide a modem interface.

41. A processor based system as called for in claim 34, wherein said processor is further programmed to provide means for digital/analog conversion.

42. A processor based system as called for in claim 34, wherein said processor is further programmed to provide a CODEC conversion.

43. A processor based system as called for in claim 34, wherein said processor is further programmed to provide means for protocol selection and implementation.

44. A processor based system as called for in claim 34, wherein said processor is further programmed to provide means for verifying the data modes or classes.
